(19) United States
(12) Patent Application Publication
(10) Pub. No.: US 2009/0163659 A1
(43) Pub. Date: Jun. 25, 2009

(54) Soft touch, low gloss polymer resins

(76) Inventors: Gregory Gemeinhardt, Park Hills, KY (US); Chuan-Ju Chen, Hebron, KY (US); Frank D. Brauer, Lawrenceburg, IN (US)

Correspondence Address: LANXESS CORPORATION, 111 RIDC PARK WEST DRIVE, PITTSBURGH, PA, 15275-1112, US

(21) Appl. No.: 12/308,003

(22) PCT Filed: May 18, 2007
(86) PCT No.: PCT/US2007/012224

§ 371 Date: Dec. 4, 2008

Related U.S. Application Data
(60) Provisional application No. 60/811,610, filed on Jun. 7, 2006.

(51) Int. Cl. C08L 51/04

(52) U.S. Cl. 525/64

(57) ABSTRACT

The present invention is directed to polymer resins having soft touch and low gloss and methods of making the same. The polymer resins comprise at least one grafted rubber copolymer, at least one polyester copolymer and at least one acrylate copolymer or a vinylacetate copolymer.

### BACKGROUND

Soft touch polymers have been found to provide great advantages in many industries including but not limited to the automotive and boating industries where these polymers provide everything from trim components, to grips on steering wheels and shifters, to air bags. Electronics industries also utilize soft touch polymers on the grips and protective coverings of many handheld electronic devices. In each case, the polymer must be soft to the touch and tough to absorb wear and tear. A low gloss finish is also desirable.

### SUMMARY

Embodiments of the present invention include a polymer resin that may include at least one grafted rubber copolymer, at least one polyester copolymer, and at least one acrylate copolymer. The grafted rubber copolymer may be may be from about 40% to about 85% by weight of the total polymer in some embodiments, and in others, may be from about 50% to about 60% by weight of the total resin.

Polymer resins in some embodiments of the present invention may have a Shore D hardness of less than 70 and may have a gloss at 60 degrees on a 0.050 inch thick extruded strip of less than about 20.

In embodiments of the invention, the polyester copolymer of the polymer resin may be from about 5% to about 50% of the total polymer resin, and in others, the polyester copolymer may be from about 20% to about 30% by weight of the total polymer resin. In other embodiments of the invention, the acyrlate copolymer may be from about 10% to about 50% of the total polymer resin and, in others, may be from about 20% to about 30% by weight of the total polymer resin.

In some embodiments, the grafted rubber copolymer may be made up of a graft/matrix such as but not limited to styrene, alpha methyl styrene, acrylanitrile, methyl methacrylate and combinations of these, and the rubber component may be selected from polybutadiene, EPDM (ethylene propylene diene), acrylate rubber and combinations of these.

The grafted rubber copolymer in some embodiments may have a rubber content of from about 1% to about 35% by weight of the graft rubber copolymer and may have rubber particles with an average particle size of from about 0.08 microns to about 10 microns in diameter.

In certain embodiments of the invention, the at least one acrylate copolymer may be an ethylene alkyl acrylate copolymer, and in others, the ethylene alkyl acrylate copolymer may be ethylene methyl acrylate, ethylene ethyl acrylate, ethylene butyl acrylate and the like or combinations of these. In some embodiments, ethylene methyl acrylate may be a copolymer of ethylene and from about 9% to about 25% methyl acrylate. In others, ethylene ethyl acrylate may be a copolymer of ethylene and from about 12% to abour 15% ethyl acrylate, and in yet others, ethylene butyl acrylate may be a copolymer of ethylene and from about 7% to about 27% butyl acrylate.

In other embodiments, the polyester copolymer may be made up of hard segments such as but not limited to polybutylene terephthalate, polyethylene terephthalate and the like and combinations of these and soft segments such as but not limited to alkyl glycols, alkylene glycols and the like and combinations of these. The Shore D hardness of polyester copolymers, in some embodiments of the invention, may be from about 25 to about 77, and the polyester copolymers may have a melt temperature from about 150° C. to about 220° C. In still other embodiments, the polyester copolymer may have a flexural modulus of from about 8,800 PSI to about 100,000 PSI.

Further embodiments of the present invention include a polymer resin having at least one grafted rubber copolymer, at least one polyester copolymer, and at least one vinyl acetate copolymer. The grafted rubber copolymer may be may be from about 40% to about 75% by weight of the total polymer in some embodiments, and in others, may be from about 50% to about 60% by weight of the total resin.

In embodiments having at least one vinyl acetate copolymer, the vinyl acetate copolymer may be ethylene vinyl acetate copolymers.

Yet other embodiments of the invention include a method for making a polymer resin that includes melt mixing at least one grafted rubber copolymer, at least one polyester copolymer, and at least one acrylate copolymer, or alternatively at least one grafted rubber copolymer, at least one polyester copolymer, and at least one vinyl acetate copolymer, and extruding the mixture. In some embodiments of the invention, the melt mixing may take place in a continuous mixer or a batch mixer, and the extruding may take place in a single or twin screw extruder. In additionally embodiments, the polymer resin may be formed into sheets in a second extruder or formed in an injection mold.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “monomer” is a reference to one or more monomers and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. Nothing herein is to be construed as an admission that the invention is not entitled to antedate such disclosure by virtue of prior invention.

As used herein, the term “about” means plus or minus 10% of the numerical value of the number with which it is being used. Therefore, about 50% means in the range of 450%-55%.

Embodiments of the present invention include compositions of styrenic polymer resins having a soft touch feel and low gloss. The compositions of the present invention may include a blend of thermoplastic elastomers and at least one grafted rubber copolymer. In further embodiments, the blend of thermoplastic elastomers may be made up of a blend of two elastomers and a grafted rubber copolymer, and in particular embodiments, the blend of elastomers may include at least one acrylate copolymer and at least one polyester copolymer.

Compositions of the present invention may be “soft touch” indicating that they have a Shore D Hardness less than about 70 as determined using the ASTM D2240 protocol and a gloss less than about 20 as measured at 60 degrees on 0.05″ thick extruded strip from a 1″ Killion extruder at 380 F. barrel and die temperature and 100 screw rpm. Additionally, compositions of the present invention may have an impact strength greater than about 4.0 as determined using the ASTM D3763 protocol using a 0.50″ dart diameter and 6000″/minute from a Fractovis impact testing machine.

In embodiments of the present invention, the total graft rubber copolymer content of the polymer resins may be from about 40% to about 85% of the total weight of the polymer resins, preferably, from about 50% to about 60%. Grafted rubbers suitable for use in the present invention are well known in the art and such grafted rubbers are readily available. Examples of grafted rubbers copolymers include but are not limited to copolymers having a graft/matrix component such as but not limited to styrene, alpha methylstyrene, acrylanitrile, methyl methacrylate and the like and combinations thereof and having a rubber component such as but not limited polybutadiene, EPDM (ethylene propylene diene), acrylate rubber, and the like and combinations of these.

In general, graft rubber copolymers that may be used in the present invention include but are not limited to rubber modified mass, solution, mass/suspension or mass/solution polymerized monovinylidene aromatic/ethylenically unsaturated nitrile graft copolymers and may have discrete rubbery polymer particles dispersed throughout the rubber. The discrete rubbery particles may serve as a substrate for the aromatic copolymer of the graft rubber and may make up a grafted superstrate and may have an average particle size of from about 0.08 microns to about 10 microns, preferably, from about 0.05 microns to about 5 microns. The remainder of aromatic copolymer may constitute a matrix phase in which the rubbery particles are dispersed that may constitute from about 40% to about 95% (preferably from about 60% to about 80%) of the overall weight of the rubber-modified grafted rubber. The grafted copolymer constituent may have a grafted superstrate to rubber matrix substrate ratio (i.e., a graft to rubber or “G/R” ratio) of from about 0.1:1 to about 2:1, preferably, from about 0.25:1 to about 0.8:1.

Aromatic monomers suitable for use in the rubber-modified monovinylidene aromaticlethylenically unsaturated nitrile copolymers of the present invention may include monovinylidene aromatic copolymers such as but not limited to styrene, alkyl substituted styrenes such as alpha.-alkyl-styrene (e.g., .alpha.-methylenestyrene, .alpha.-ethylstyrene, etc.), various ring-substituted styrenes such as ortho or para-methylstyrene, ortho-ethylstyrene, 2,4-dimethylstyrene, etc., ring-substituted halo-styrenes such as chloro-styrenes, 2,4-chloro-styrene, etc. and the like. Monovinylidene aromatic monomers (especially styrene) may constitute from about 55 to about 99 weight % of the monovinylidene aromatic copolymer, preferably, from about 60 to 95 weight % and, more preferably, from about 65 to about 90 weight %. Monovinylidene aromatic copolymers may be solid, hard (i.e., non-elastomeric) materials having a glass transition temperature in excess of 25° C.

In some embodiments, ethylenically unsaturated nitrile monomers may be part of the grafted rubbers of the present invention and may constitute from about 1 to about 45 weight %, preferably, from 5 to 40 weight % and, more preferably, from 10 to 35 weight % of the indicated aromatic copolymers. Ethylenically unsaturated nitrile monomers may include but are not limited to acrylonitrile, methacrylonitrile, ethylacrylonitrile, and furmaronitrile.

Rubber modified aromatic copolymers may also contain additional monomer ingredients that may be present in from about 1 to about 25%, preferably, from about 2 to about 15% by weight of the rubber modified aromatic copolymer. Examples of suitable monomer ingredients include but are not limited to ethylenically unsaturated anhydrides such as maleic anhydride; ethylenically unsaturated amides such as acrylamide, methacrylamide; esters, including lower alkyl esters such as C₁-C₆ alkyl esters, of ethylenically unsaturated carboxylic acids such as but not limited to methyl methacrylate and 2-ethylhexylacrylate; ethylenically unsaturated dicarboxylic acid imides such as but not limited to N-alkyl or N-aryl maleimides such as N-phenyl maleimide and the like.

In certain embodiments, the matrix phase portion of the polymerized rubber modified aromatic copolymer has a solubility parameter of from about 9.0 to about 10.2 (preferably from about 9.2 to 10.0) as calculated pursuant to the method described in Polymer Blends, Academic Press, pp 45-48, 1978, edited by D. R. Paul and S. Newman, herein incorporated by reference in it's entirety.

Suitable rubbery polymer materials for use as the dispersed rubbery particles, both within the rubber modified aromatic copolymer include but are not limited to homopolymers of 1,3-conjugated alkadiene monomers; copolymers of from about 60% to about 99 weight % of the 1,3-conjugated alkadienes with from about 1% to about 40 weight % of one or more monoethylenically unsaturated monomers such as, for example, monovinyldiene aromatic monomers such as styrene, and the like; and ethylenically unsaturated nitrites such as, for example, acrylonitrile, methacrylonitrile, and the like; alkyl acrylate or methacrylate monomers such as, for example, methyl methacrylate and the like; ethylene/propylene copolymer rubbers; and rubbery ethylene/propylene/non-conjugated diene copolymers.

In certain embodiments, rubbery copolymers used in the present invention may include polymers composed of from about 60% to 100 weight % of 1,3-butadiene and from 0% to 40 weight % of styrene or acrylonitrile. Rubbery polymers suitable for the present invention may have a glass transition temperature of about −20° C. or lower, preferably, −30° C. or lower.

In some embodiments of the present invention, mass polymerized rubber modified aromatic copolymers may be from about 1% to 35 weight %, preferably, from about 5% to 25% of the above-discussed dispersed rubbery polymer particles. In other embodiments, emulsion polymerized grafted rubber may have a dispersed rubber polymer content of from about 35% to about 85 weight %, preferably, from about 40% to about 85% and, most preferably, from about 45% to about 80% by weight of the grafted rubber.

Mass polymerized aromatic graft copolymer suitable for the present invention may be prepared by any method known in the art such as but not limited to conventional mass, solution, mass/suspension or mass/solution graft polymerization process conducted in the presence of the desired rubbery polymer material.

Emulsion polymerized grafted rubber may be prepared in accordance with the various well known emulsion graft polymerization methods and techniques, and alternatively, commercially available emulsion polymerized grafted rubbers may be used. Emulsion polymerized grafted rubber suitable for the present invention may have a relatively high rubber content wherein the grafted superstrate polymer may include but may not be limited to a monovinylidene aromatic/ethylenically unsaturated nitrile copolymer such as the those more fully discussed and described in connection with the mass polymerized graft copolymer. Other suitable grafted rubbers may include rubber concentrate ingredients having a grafted superstrate polymer that may include but may not be limited to an acrylate or methacrylate polymer such as, for example, polymethyl methacrylate, various methyl methacrylate copolymers, and the like.

In embodiments of the present invention, suitable emulsion polymerized graft rubbers include but are not limited to alkyl acrylate graft rubbers, such as for example, ethyl acrylate, butyl acrylate and the like.

Thermoplastic elastomers (TPEs) of the present invention may include but are not limited to acrylate copolymers such as but not limited to ethylene alkyl acrylate, for example, ethylene methyl acrylate and the like and polyester copolymers such as but not limited to polyester polyether copolymers and the like. In embodiments of the present invention acrylate copolymers and polyester copolymers are individually from about 10% to about 50% by weight of the resin, in some embodiments, from about 20% to about 30 weight %. The ratio of acrylate copolymers to polyester copolymers may be from about 1:1 to about 1:3 or from about 1:1 to about 3:1.

Acrylate copolymers may be any acrylate copolymer available to one of ordinary skill in the art such as but not limited to ethylene acrylate copolymers, and in certain embodiments, ethylene alkyl acrylate copolymers including but are not limited to ethylene methyl acrylate, ethylene ethyl acrylate, ethylene butyl acrylate and the like and combinations of these. In embodiments of the invention where the acrylate copolymer is the copolymer of ethylene and methyl acrylate, the acrylate copolymer may be from about 9 to about 25% methyl acrylate. In embodiments where the acrylate copolymer is the copolymer of ethylene and ethyl acrylate, the acrylate copolymer may be form about 12 to about 15% ethyl acrylate, and in embodiments where the acrylate copolymer is the copolymer of ethylene and butyl acrylate, the acrylate copolymer may be from about 7 to about 27% butyl acrylate.

In some embodiments of the invention, the acrylate copolymer may be replaced by at least one vinyl acetate copolymer. The polymer resin may, therefore, be made up of at least one grafted rubber copolymer, at least one polyester copolymer, and at least one vinyl acetate copolymer in embodiments of the invention. In certain embodiments, the at least one vinyl acetate copolymer may be ethylene vinyl acetate.

Polyester copolymers of the present invention may be any polyester copolymer available to one of ordinary skill in the art including polyester copolymers that are commercially available. In some embodiments, the polyester copolymers may be made up of hard and soft segments. Hard segments may include but are not limited to polybutylene terephthalate, polyethylene terephthalate and the like and combinations of these, and soft segments may include but are not limited to alkyl glycols, alkylene glycols and the like. In some embodiments of the present invention, the Shore D hardness of the polyester copolymer is from about 25 to about 77. In other embodiments, the melt temperature of the polymer resin is from about 150 to about 220° C., and in others, the flexural modulus is from about 8,800 to about 10,000 PSI.

The resins of the present invention may be made by any method known in the art. In some embodiments of the invention a graft rubber copolymer, a polyester copolymer and a acrylate copolymer are combined and melt mixed to form a mixture, the mixture is placed in an extruder where the resin is formed. In some embodiments of the invention, melt mixing may take place in a batch or continuous mixer, and extrusion may take place in a single or twin screw extruder. In still other embodiments, the resin may be formed using an injection molder. In yet other embodiments, the resin may be formed into sheets using a second extruder.

This invention and embodiments illustrating the method and materials used may be further understood by reference to the following non-limiting examples.

### EXAMPLES

Generally, pellets of ABS, ASA or AES were pre-blended with the pellets of one or more of the TPE materials. The composition of the graft rubber copolymers used is provided with Tables 1 and 2. Riteflex is a commercially available polyester copolymer whose Shore D hardness is noted as the last two digits of the compound name, and Elvaloy is a commercially available acrylate copolymer whose percent methyl acrylate is indicated as the last two digits of the compound name. Once blended, the pellets were fed into a twin-screw extruder (Coperion W&P ZSK30) for melt mixing, equipped with a strand die where the strands passed through a water bath and pelletizer Typical extrusion conditions were 240° C., 300 rpm, 50 lb/hr. The pellets were then dried and extruded into 0.050° strips using a 1″ Killion extruder at 380° C. and 100 rpm. Testing was then carried out on the 0.050″ strips to determine gloss, Shore D, and Fractovis impact energy.

The standard procedure described above was used in each of the examples illustrated in Table 1 and Table 2. The amount of each constituent in weight percent is indicated, and the Shore D hardness, Gloss and Impact strength for each copolymer are provided in each Table.

TABLE 1

| | A | B | C | D | E | F | G | H | I | J | K | L |
|---|---|---|---|---|---|---|---|---|---|---|---|---|
| ABS-1 | 100 | 50 | 50 | 50 | 50 | 50 | 50 | 50 | 50 | 50 | 50 | 50 |
| Riteflex 425 | | 50 | | | | | | 25 | 25 | 25 | | 20 |
| Riteflex 440 | | | 50 | | | | | | | | | |
| EM 400 | | | | 50 | | | | | | | 20 | |
| Elvaloy 1820 AC | | | | 50 | | | 25 | | | | 30 | 30 |
| Elvaloy 2715 AC | | | | | 50 | | | | 25 | | | |
| Elvaloy 3717 AC | | | | | | 50 | | | | 25 | | |
| Hardness* | 72 | 46 | 54 | 48 | 42 | 47 | 46 | 45 | 45 | 45 | 45 | 44 |
| (Shore D) | | | | | | | | | | | | |
| Gloss** | 3.4 | 23.3 | 24.2 | 46.8 | 9.7 | 13.6 | 10.3 | 8.2 | 7.5 | 7.5 | 11.7 | 10 |
| (60 deg) | | | | | | | | | | | | |
| Impact | 3 | 8.2 | 7.1 | 6.1 | 2.4 | 1 | 0.7 | 5.1 | 4.6 | 4.5 | 6 | 5.7 |
| Strength*** | | | | | | | | | | | | |

ABS-1 Acrylonitrile-Butadiene-Styrene by continuous mass process having rubber content of 15% and rubber particle size of 4.5 microns
*Hardness: ASTM D2240 (Durometer Hardness-Shore)
**Gloss: measured at 60 degrees on 0.050″ thick extruded strip from 1″ Killion extruder at 380 F. barrel and die temperature and 100 screw rpm
***Impact Strenght: ASTM D3763, 0.5″ dart diameter and 6000″/min. velocity from Fractovis impact testing machine

TABLE 2

| | A | B | C | D | E | F |
|---|---|---|---|---|---|---|
| ABS-1 | 50 | | | | | |
| ABS-2 | | 50 | | | | |
| ABS-3 | | | 50 | | | |
| ASA | | | | 50 | 50 | 50 |
| Riteflex | 25 | 25 | 25 | 25 | 25 | 25 |
| 425 | | | | | | |
| Elvaloy | 25 | 25 | 25 | 25 | | |
| 1820 AC | | | | | | |
| Elvaloy | | | | | 25 | |
| 2715 AC | | | | | | |
| Elvaloy | | | | | | 25 |
| 3717 AC | | | | | | |
| Hardness* | 45 | 52 | 48 | 41 | 42 | 43 |
| (Shore D) | | | | | | |
| Gloss** | 8.2 | 6.9 | 9 | 6.9 | 5.8 | 5.3 |
| (60 deg) | | | | | | |
| Impact | 5.1 | 6.7 | 7.2 | 5.9 | 5.2 | 5.1 |
| Strength*** | | | | | | |

ABS-1 Acrylonitrile-Butadiene-Styrene by continuous mass process having rubber content of 15% and rubber particle size of 4.5 microns (weight-average)
ABS-2 Acrytonitrile-Butadiene-Styrene by continuous mass process having rubber content of 17% and rubber particle size of .7 microns (weight-average)
ABS-3 Acrylonitrile-Butadiene-Styrene by emulsion process having rubber content of 22.5% and rubber particle size of .54 microns (weight-average)
ASA Acrylonitrile-Styrene-Acrylate by emulsion process having rubber content of 21.8% and rubber particle size of .36 microns (weight-average)
*Hardness: ASTM D2240 (Durometer Hardness-Shore)
**Gloss: measured at 60 degrees on 0.050″ thick extruded strip from 1″ Killion extruder at 380 F. barrel and die temperature and 100 screw rpm
***Impact Strenght: ASTM D3763, 0.5″ dart diameter and 6000″/min. velocity from Fractovis impact testing machine

Although the present invention has been described in considerable detail with reference to certain preferred embodiments thereof other versions are possible. Therefore the spirit and scope of the appended claims should not be limited to the description and the preferred versions contained within this specification.

What is claimed is:

1. A polymer resin comprising:
at least one grafted rubber copolymer;
at least one polyester copolymer; and
at least one acrylate copolymer;
wherein the grafted rubber copolymer comprises about 40% to about 85% by weight of the total polymer resin.

2. The polymer resin of claim 1, wherein the grafted rubber copolymer comprises about 50% to about 60% by weight of the total polymer resin.

3. The polymer resin of claim 1, wherein the polyester copolymer is from about 5% to about 50% by weight of the total polymer resin.

4. The polymer resin of claim 1, wherein the polyester copolymer is from about 20% to about 30% by weight of the total polymer resin.

5. The polymer resin of claim 1, wherein the acrylate copolymer is from about 10% to about 50% by weight of the total polymer resin.

6. The polymer resin of claim 1, wherein the acrylate copolymer is from about 20% to about 30% by weight of the total polymer resin.

7. The polymer resin of claim 1, wherein the grafted rubber copolymer comprises
a graft/matrix selected from the group consisting of styrene, alpha methyl styrene, acrylanitrile, methyl methacrylate, and combinations thereof; and
a rubber selected from the group consisting of polybutadiene, EPDM (ethylene propylene diene), acrylate rubber, and combinations thereof.

8. The polymer resin of claim 1, wherein the grafted rubber copolymer has a rubber content of about 1 to about 35% by weight of the grafted rubber copolymer.

9. The polymer resin of claim 1, wherein the grafted rubber copolymer has rubber particles with an average particle size of from about 0.08 microns to about 10 microns in diameter.

10. The polymer resin of claim 1, wherein the at least one acrylate copolymer is selected from ethylene alkyl acrylates.

11. The polymer resin of claim 10, wherein the ethylene alkyl acrylate is selected from the group consisting of ethylene acrylate, ethylene methyl-acrylate, ethylene ethyl-acrylate, ethylene butyl-acrylate and combinations thereof.

12. The polymer resin of claim 9, wherein the ethylene methyl-acrylate is the copolymer of ethylene and methyl acrylate comprising from about 9% to about 25% methyl acrylate.

13. The polymer resin of claim 9, wherein the ethylene ethyl-acrylate is the copolymer of ethylene and ethyl acrylate comprising from about 12% to about 15% ethyl acrylate.

14. The polymer resin of claim 9, wherein the ethylene butyl-acrylate is the copolymer of ethylene and butyl acrylate comprising from about 7% to about 27% butyl acrylate.

15. The polymer resin of claim 1, wherein the polyester copolymer comprises:
hard segments selected from the group consisting of polybutylene terephthalate, polyethylene terephthalate, and combinations thereof; and
soft segments selected from alkyl glycols, alkylene glycols and combinations thereof.

16. The polymer resin of claim 1, wherein the polyester copolymer has a Shore D hardness of from about 25 to about 77.

17. The polymer resin of claim 1, wherein the polyester copolymer has a melt temperature of from about 150° C. to about 220° C.

18. The polymer resin of claim 1, wherein the polyester copolymer has a flexural modulus of from about 8,800 PSI to about 100,000 PSI.

19. The polymer resin of claim 1, wherein the Shore D hardness is less than 70.

20. The polymer resin of claim 1, wherein the gloss measured at 60 degrees on a 0.050 inch thick extruded strip is less than about 20.

21. A polymer resin comprising:
at least one grafted rubber copolymer;
at least one polyester copolymer; and
at least one vinyl acetate copolymer;
wherein the grafted rubber copolymer comprises about 40% to about 75% by weight of the total polymer resin.

22. The polymer resin of claim 21, wherein the at least one vinyl acetate copolymer is ethylene vinyl acetate copolymer.

23. A method for making a polymer resin comprising:
melt mixing at least one grafted rubber copolymer, at least one polyester copolymer, and at least one acrylate copolymer to form a mixture; and
extruding the.

24. The method of claim 23, wherein the melt mixing takes place in a means for mixing selected from a continuous mixer, batch mixer, injection molder, and an extruder.

25. The method of claim 23, wherein the extrusion takes place in an extruder selected from a single or twin screw extruder.

26. The method of claim 23, further comprising a second extrusion step wherein the polymer resin is formed into a continuous sheet.
